(19) United States
(12) Patent Application Publication
(10) Pub. No.: US 2014/0344947 A1
(43) Pub. Date: Nov. 20, 2014

(54) METHOD AND APPARATUS FOR HANDLING STORAGE OF CONTEXT INFORMATION

(71) Applicant: ADVANCED MICRO DEVICES, INC., SUNNYVALE, CA (US)

(72) Inventors: Nathan Kalyanasundharam, San Jose, CA (US); Sebastien Nussbaum, Lexington, MA (US)

(73) Assignee: ADVANCED MICRO DEVICES, INC., SUNNYVALE, CA (US)

(21) Appl. No.: 14/282,442

(22) Filed: May 20, 2014

Related U.S. Application Data
(60) Provisional application No. 61/825,460, filed on May 20, 2013.

(51) Int. Cl. G06F 21/60

(52) U.S. Cl. CPC G06F 21/60
USPC 726/26

(57) ABSTRACT

A method and apparatus is provided for improving security of context information of processing circuitry of a processing device. In one example, the method and apparatus stores context information of the processing circuitry on an external storage medium at a first location as part of the processing circuitry entering a first power state, and stores the context information of the processing circuitry on the storage medium at a second location as part of the processing circuitry entering a second, later and different power state.

The present application is based on and claims priority to provisional application Ser. No. 61/825,460, entitled “METHOD AND APPARATUS FOR HANDLING STORAGE OF CONTEXT INFORMATION,” filed on May 20, 2013, the entire disclosure of which is hereby expressly incorporated herein by reference.

### FIELD OF THE DISCLOSURE

The present disclosure generally relates to context information of processing circuitry, and more particularly to improving security of context information.

### BACKGROUND OF THE DISCLOSURE

The disclosure relates generally to a method and apparatus for improving the security of context information of a processing device, and more particularly to a method and apparatus for storing such context information in different locations within a storage medium in response to different instances of entry of processing circuitry of the processing device into different power states.

Many complex processors or systems on a chip (“SOC”) such as processing devices used in video game consoles and other applications contain digital media content that is copyrighted or other proprietary system information that needs to be secure. Such data is typically stored in an encrypted format. Unfortunately, hackers sometimes purchase consoles with the goal of identifying the encryption keys used to protect the contents of the processing devices. With the encryption keys identified, the hacker can decrypt the content and exploit it in a variety of ways.

In some instances, hackers attempt to decrypt context information relating to one or more processing cores of processing circuitry in a processing device. Context information may include any information regarding the state of operation of a processing core, and in the context of this disclosure, includes any information regarding the state of operation of a processing core, sometimes referred to as operational state data, at the time the processing core is placed in an inactive or idle state which permits the processing core (or a different processing core) to resume operation using the same states of operation when the processing core is later returned to an active state. As those of ordinary skill in the art are aware, there are frequently more than simply two power states (i.e., more than simply an active and inactive state). This context information may include, among other things, information regarding the architectural or sub-architectural state of the processing core, knowledge of which may provide the hacker with data from which the hacker may duplicate programs, execute unauthorized code, or otherwise gain access to proprietary information.

It is typical to store context information on a storage medium in response to entry of the processing core into a power state such as an inactive state, which is typically a state wherein the processing core consumes less power than when it is active. If such context information is not stored, then when the processing core is returned to an active state, it must complete a reset or re-boot operation that is time consuming or otherwise unacceptable in the application of the processing workload. By storing the context information, the processing core (or another processing core of the processing circuitry) may more quickly resume operation when re-activated.

The processing device may place one or more processing cores of the processing circuitry into an inactive state (or sleep state) under a variety of circumstances, including when the processing core is not required for the current processing workload of the processing device, when the processing core would benefit in terms of long-term reliability by sharing the processing workload with one or more other processing cores of the processing device, and/or when the processing device determines that distributed processing among a plurality of processing cores would improve the distribution of thermal characteristics of the plurality of processing cores.

The context information of a processing core is typically stored in an encrypted format in a storage medium at a predetermined memory location or address. The data comprising the context information may, however, be identified as a particular type of data (e.g., control register data) and de-encrypted through diligent efforts of a hacker through reverse engineering and evaluation (even by trial and error) of the encrypted context information. In other words, if the hacker knows the identity of the data and its location on the storage medium, then the hacker only needs to determine the encryption keys used to encrypt the context information to gain access to the data for unauthorized purposes.

Some attempts to reduce the security risks associated with context information hacking have included approaches wherein the context information is stored in a storage medium that resides on the processing device. One of the drawbacks of such approaches is that significant additional storage space is required on the processing device, which impacts the size and cost of the processing device. In other approaches, the context information is secure from access by hackers while resident on the processing device (e.g., by control of use of I/O ports of the processing device), but the context information remains vulnerable to hacking when stored “off-chip” on an external storage medium.

Accordingly, there exists a need for an improved method and apparatus for handling storage of context information during various power states of operation of a processing circuit to inhibit unauthorized access to the context information and thereby address one or more of the above-noted drawbacks.

### SUMMARY OF EMBODIMENTS OF THE DISCLOSURE

According to one embodiment of the present disclosure, a method for improving security of context information of processing circuitry is provided. The method includes storing context information of the processing circuitry on a storage medium at a first location in a process of the processing circuitry entering a first power state, and storing context information of the processing circuitry on the storage medium at a second location in a process of the processing circuitry entering a second, later and different power state. In one aspect of this embodiment, the processing circuitry includes a plurality of processing cores and storing context information of the processing circuitry includes storing context information of one of the plurality of cores. In another aspect of this embodiment, the method further includes retrieving the context information from the second location in a process of the processing circuitry exiting the second, later power state, and using the context information for operation of another of the plurality of cores. In another aspect of this embodiment, the processing circuitry is an integrated circuit and the storage medium is a separate integrated circuit, such as a DRAM. In yet another aspect of this embodiment, the second, later power state is immediately subsequent to the first power state. In another aspect of this embodiment, the method includes encrypting the context information before storing the context information. In still another aspect, the method includes programming in a base address register of the processing circuitry a location of the storage medium for storing the context information.

Another embodiment of the present disclosure provides a computer-readable storage medium storing instructions that, when executed by a security module of a processing device having processing circuitry, cause the processing device to store context information of the processing circuitry on an off-chip storage medium at a first location in a process of the processing circuitry entering a first power state, and store context information of the processing circuitry on the storage medium at a second location in a process of the processing circuitry entering a second, later and different power state. In one aspect of this embodiment, the processing circuitry includes a plurality of processing cores and stored context information includes context information of one of the plurality of cores. In another aspect of this embodiment, the instructions, when executed by the security module, further cause the processing device to retrieve the context information from the second location in a process of the processing circuitry exiting the second, later power state, and use the context information for operation of another of the plurality of cores. In another aspect of this embodiment, the storage medium is a DRAM. In still another aspect, the second, later power state is immediately subsequent to the first power state. In yet another aspect of this embodiment, the instructions, when executed by the security module, further cause the processing device to encrypt the context information before storing the context information. In another aspect, the instructions, when executed by the security module, further cause the processing device to program in a base address register of the processing circuitry a location of the storage medium for storing the context information.

Still another embodiment of the present disclosure provides an apparatus, including processing circuitry, a memory including a plurality of instructions, and a security module operatively coupled to the memory and the processing circuitry. In this embodiment, the security module is configured to execute the instructions to store context information of the processing circuitry on an external storage medium at a first location in a process of the processing circuitry entering a first power state, and store context information of the processing circuitry on the storage medium at a second location in a process of the processing circuitry entering a second, later and different power state. In one aspect of this embodiment, the processing circuitry includes a plurality of processing cores and the stored context information includes context information of one of the plurality of cores. In another aspect of this embodiment, the security module facilitates retrieval of the context information from the second location in a process of the processing circuitry exiting the second, later power state, and the context information is used for operation of another of the plurality of cores. In still another aspect, the storage medium is a DRAM. In another aspect of this embodiment, the second, later power state is immediately subsequent to the first power state. In another aspect, the security module encrypts the context information before storing the context information. In yet another aspect of this embodiment, the security module programs in a base address register of the processing circuitry a location of the storage medium for storing the context information.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating a processing device according to one embodiment of the present disclosure;

FIGS. 2(a)-(d) are conceptual block diagrams illustrating the storage and use of context information of a processing core according to one embodiment of the present disclosure;

FIGS. 3(a)-(d) are conceptual block diagrams illustrating the storage and use of context information of a processing core according to another embodiment of the present disclosure; and

FIG. 4 is a flowchart illustrating one example of a method for handling storage of context information during low power operation of processing circuitry in accordance with one embodiment set forth in the disclosure.

### DETAILED DESCRIPTION OF THE PREFERRED EMBODIMENTS

Briefly, a method and apparatus is provided for handling storage of context information of a processing core when the core is placed into a power state such as an inactive state. Each time a core is placed into a state to save power, distribute the processing workload among multiple cores, or manage thermal distribution among cores, the context information for the core is stored in an external storage medium. Rather than store the context information for a particular core in the same location on the storage medium each time the core is deactivated, the method and apparatus of the present disclosure stores the context information in different locations. In this manner, it is more difficult for a potential hacker to analyze the context information and obtain proprietary information relating to the core. Additionally, the context information may be retrieved from the storage medium for resumed execution by a different core in a multi-core processing circuit. As such, not only is context information shuffled to different storage locations, but it may also be associated with different processing cores, thereby adding an additional level of complexity to prevent hacking.

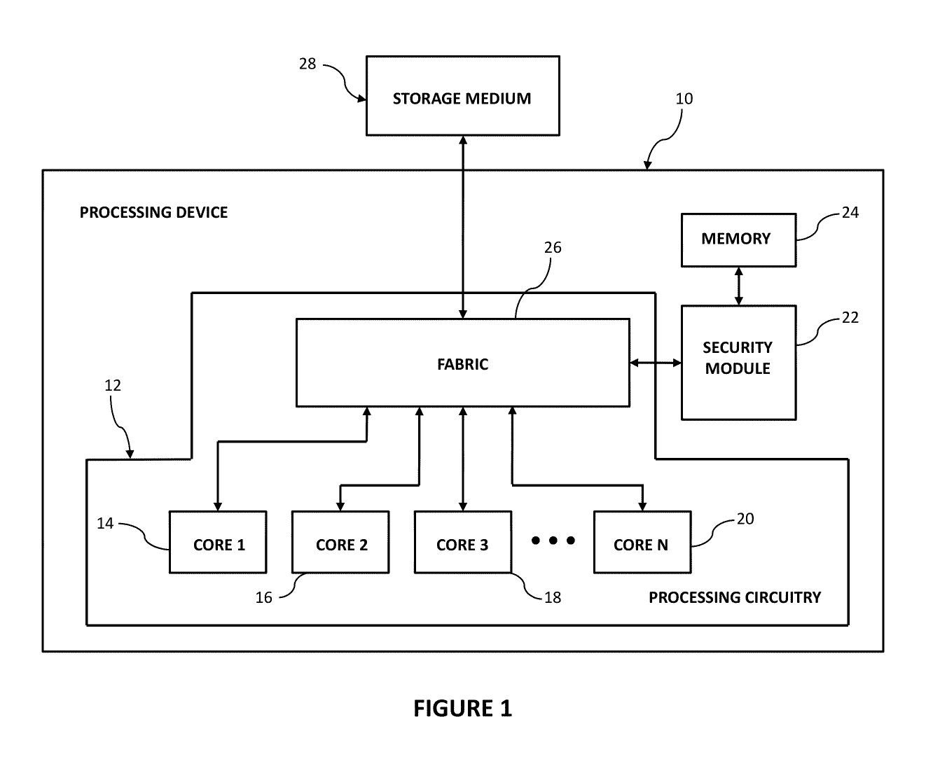

Referring now to FIG. 1, a processing device 10 is shown as including, among other components, processing circuitry 12 including a plurality of processing cores 14-20, a security module 22, a memory 24 in operative connection with security module 22, and fabric 26 that interconnects the plurality of processing cores 14-20 and security module 22. Fabric 26 also operatively connects processing device 10 to an external storage medium 28. Processing device 10 may be any of a variety of different devices such as a CPU or GPU used in computing devices such as servers, desktop and laptop computers, gaming consoles and portable computing devices including, but not limited to, notebooks, tablets and smart phones.

Processing circuitry 12 includes, in addition to cores 14-20 and fabric 26, a plurality of circuit functionality as is known to those skilled in the art. Each core 14-20 may provide stand-alone processing capability for reading and executing program instructions. While four cores 14-20 are shown in FIG. 1, it should be understood that more or fewer cores may be integrated into processing circuitry 12. Cores 14-20 may be tightly or loosely coupled together via fabric 26, have separate and/or shared memory, and communicate with one another via fabric 26.

Security module 22 includes processing circuitry for executing instructions stored in memory 24. As is further described below, security module 22 executes instructions for managing the process of storing context information in storage medium 28 upon entry of a core 14-20 into a power state (such as an inactive state) and restoring the context information to the core (or a different core) when operation is to be resumed. Security module 22 carries out the context information management techniques discussed herein for various power states (sometimes called idle states, sleep states, or C states) of cores 14-20. As is known in the art, modern processing devices 10 typically offer multiple power states, ranging from low power states that provide power consumption savings to deep power states that provide greater power consumption savings (e.g., by completely removing power to a core), but have higher entry and exit latencies. The teachings of the present disclosure apply to any of the various power states.

As mentioned above, the context information that is saved in storage medium 28 as part of entry of a core 14-20 into a power state may include any information regarding the state of operation of the core just prior to the core entering the power state which permits the core (or a different processing core) to resume operation at a later time using the same states of operation. This context information may include, among other things, information regarding the architectural or sub-architectural state of the processing core and process context such as address space, stack space, virtual address space, register set image (e.g., general processor registers such as program counter, instruction register, etc.), profiling and/or accounting information, kernel data structure snapshot, and current state of the process (e.g., waiting, ready, etc.).

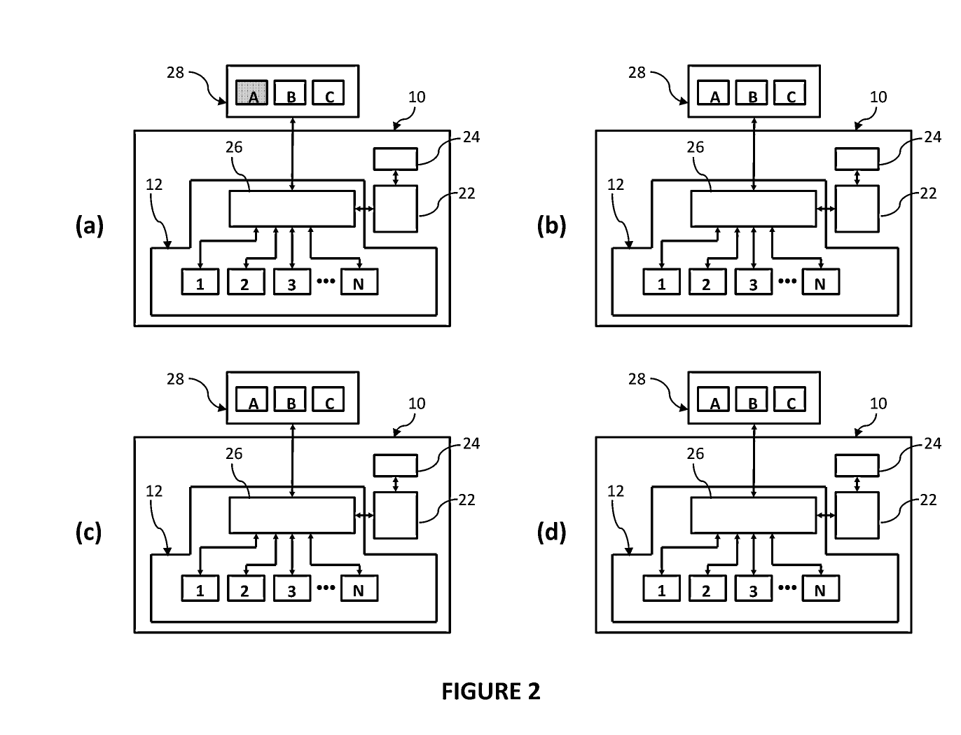

Referring now to FIGS. 2(a)-(d), in operation and for any one of a variety of different reasons such as power savings, workload distribution and/or thermal distribution, processing device 10 requests that a core 14-20 enter any one of the above-described power states. In the example of FIG. 2(a), processing device 10 has requested that core 1 (shown shaded) enter a power state. Security module 22 grants permission for core 1 to become inactive, and then programs into a base address register of fabric 26 a specification of one or more physical locations in storage medium 28 for storage of context information for core 1. It should be understood that security module 22 may use any of a variety of suitable techniques for determining the one or more physical locations in storage medium 28 to be used. In this example, the context information of core 1 is to be stored in location A (shown shaded) of storage medium 28.

Next, core 1 stores the appropriate context information using a virtual address at a virtual location in fabric 26. In one embodiment of the disclosure, the virtual address is fixed, and therefore always used by core 1 for storage of context information. Fabric 26 then converts the virtual address to the physical location (i.e., location A) of storage medium 28, and writes the context information to location A where it is stored until retrieved for resumed operation.

In this example, core 1 is to be used for resumed operation according to the context information stored in location A of storage medium 28. Processing device 10 requests that core 1 be re-activated, and security module 22 grants the request. Next, security module 22 provides the physical location in storage medium 28 containing the context information associated with core 1 just before it entered the power state (i.e., location A) to the base address register in fabric 26. Core 1 then requests the context information using the virtual address at the virtual location in fabric 26. Fabric 26 converts the virtual address to the physical location in storage medium 28 (i.e., location A) provided by security module 22. Finally, fabric 26 removes the context information from storage medium 28 and provides it to core 1 as represented by FIG. 2(b).

FIG. 2(c) represents entry of core 1 into another power state at a later time during operation of processing device 10. This time, however, context information for core 1 is stored at location B of storage medium 28. As was the case regarding the initial power state described above, processing device 10 requests that core 1 (shown shaded) enter any one of the above-described power states. Security module 22 grants permission for core 1 to become inactive, and then programs into the base address register of fabric 26 a specification of one or more physical locations in storage medium 28 for storage of context information for core 1. In this example, the context information of core 1 is to be stored in location B (shown shaded) of storage medium 28.

Next, core 1 stores the appropriate context information using the virtual address at the virtual location in fabric 26. Fabric 26 then converts the virtual address to the physical location (i.e., location B) of storage medium 28, and writes the context information to location B where it is stored until retrieved for resumed operation.

After this second power state, core 1 is again to be used for resumed operation according to the context information stored in location B of storage medium 28. Processing device 10 requests that core 1 be re-activated, and security module 22 grants the request. Next, security module 22 provides the physical location in storage medium 28 containing the context information associated with core 1 just before it entered a power state (i.e., location B) to the base address register in fabric 26. Core 1 then requests the context information using the virtual address at the virtual location in fabric 26. Fabric 26 converts the virtual address to the physical location in storage medium 28 (i.e., location B) provided by security module 22. Finally, fabric 26 removes the context information from storage medium 28 and provides it to core 1 as represented by FIG. 2(d).

In the above-described manner, processing device 10 stores context information associated with core 1 at different physical locations within storage medium 28 each time core 1 enters a power state. As such, it will be very difficult for a potential hacker to evaluate the context information because its nature is unknown, it is encrypted, and its address in storage medium 28 changes is constantly changing. It should be understood, however, that it is contemplated that the context information storage locations in storage medium 28 need not be changed for every entry into a power state. A physical location for one power state may be reused in one or more immediately subsequent power state, but some degree of variation of the physical storage location used for a particular core 14-20 must occur during operation of processing device 10. It should also be understood that security module 22 may assign or program physical storage locations at random, pursuant to an algorithm or policy, or as a function of some operating parameter of processing device 10.

It is further contemplated by the present disclosure that the context information may be hashed or scrambled prior to storage on storage medium 28. Additionally, as different regions of storage medium 28 may utilize different types of encryption techniques for context information or otherwise provide different levels of security, it is within the scope of the present disclosure for security module 22 to determine the physical storage location of context information based the level of security of the storage location, the level of sensitivity of the context information (or portion of it), and/or the desired latency upon entry into or exit from a power state.

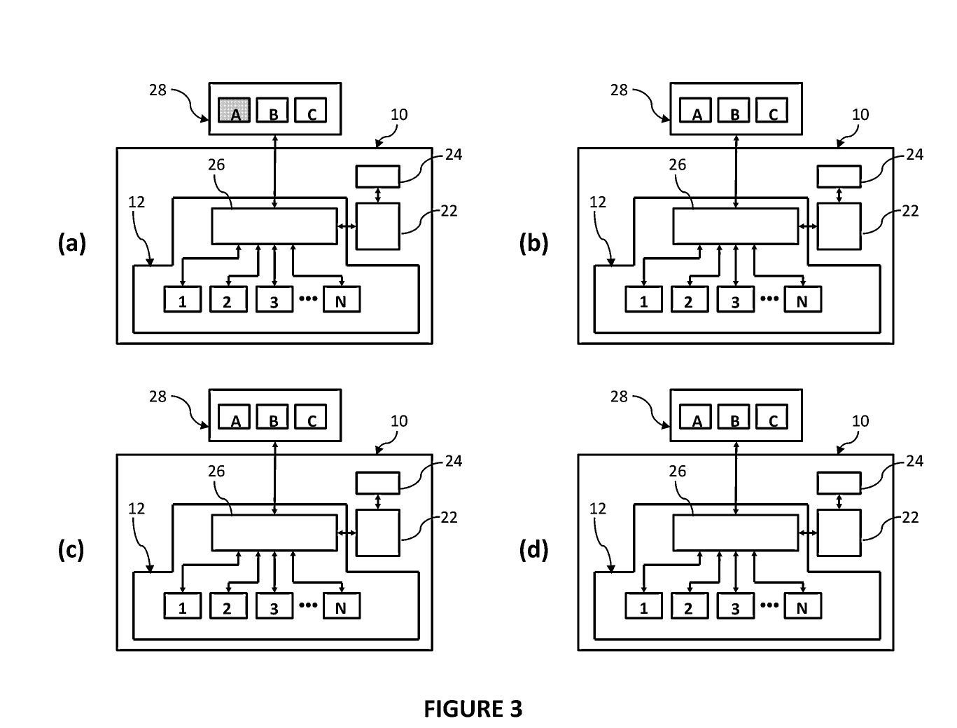

Referring now to FIGS. 3(a)-(d), another example of managing storage of context information is conceptually depicted. This example adds another level of protection of the context information against hacking by moving processing using the context information from core to core. More specifically, processing device 10 requests that core 1 (shown shaded) enter a power state. Security module 22 grants permission for core 1 to become inactive, and programs into the base address register of fabric 26 a specification of one or more physical locations in storage medium 28 for storage of context information for core 1. In this example, the context information of core 1 is to be stored in location A (shown shaded) of storage medium 28.

Next, core 1 stores the appropriate context information using the virtual address at the virtual location in fabric 26. Fabric 26 then converts the virtual address to the physical location (i.e., location A) of storage medium 28, and writes the context information to location A where it is stored until retrieved for resumed operation.

In this example, core 1 is to be used for resumed operation according to the context information stored in location A of storage medium 28. Processing device 10 requests that core 1 be re-activated, and security module 22 grants the request. Next, security module 22 provides the physical location in storage medium 28 containing the context information associated with core 1 just before it entered a power state (i.e., location A) to the base address register in fabric 26. Core 1 then requests the context information using the virtual address at the virtual location in fabric 26. Fabric 26 converts the virtual address to the physical location in storage medium 28 (i.e., location A) provided by security module 22. Finally, fabric 26 removes the context information from storage medium 28 and provides it to core 1 as represented by FIG. 3(b).

FIG. 3(c) represents entry of core 1 into another power state at a later time during operation of processing device 10. This time, however, context information for core 1 is stored at location B of storage medium 28 in the manner described above with reference to FIG. 2(c). In this example, however, after core 1 enters this second power state, processing device 10 determines that core 3 (shown shaded in FIG. 3(d)) is to be used for resumed operation according to the context information stored in location B of storage medium 28. Processing device 10 requests that core 3 be activated, and security module 22 grants the request. Next, security module 22 provides the physical location in storage medium 28 containing the context information associated with core 1 just before it entered a power state (i.e., location B) to the base address register in fabric 26. Core 3 then requests the context information using the virtual address at the virtual location in fabric 26. Fabric 26 converts the virtual address to the physical location in storage medium 28 (i.e., location B) provided by security module 22. Finally, fabric 26 removes the context information from storage medium 28 and provides it to core 3 as represented by FIG. 2(d).

It should be understood that processing device 10 may determine to move processing from core to core to make it even more difficult for a potential hacker to determine the context information associated with a particular core. In other words, not only does processing device 10 move the context information from location to location within storage medium 28 as part of placing cores into power states, but processing device 10 also moves the processing according to the context information from core to core. It should further be understood that processing device 10 may determine to move processing to another core to provide benefits in addition to added security such as better thermal distribution among cores 14-20 and better overall long term reliability of the cores 14-20 in processing circuitry 12.

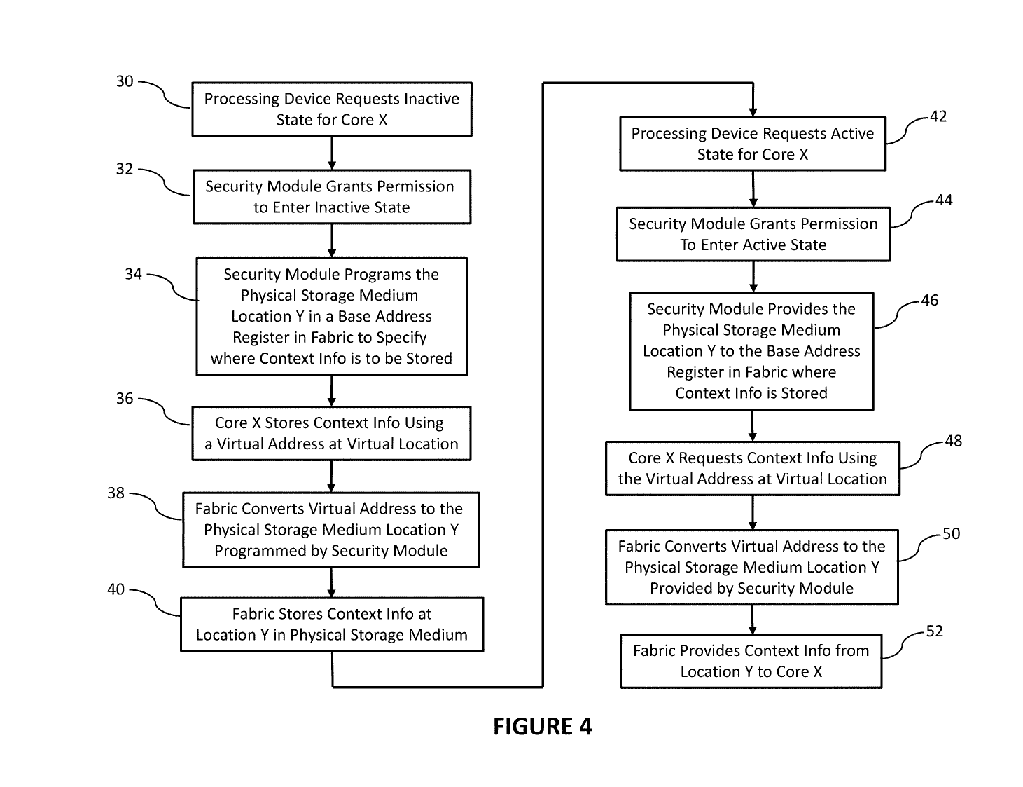

FIG. 4 depicts a flow chart of steps performed in the process of handling storage of context information according to the teachings of the present disclosure. The process of FIG. 4 is repeat each time a core 14-20 is placed into a power state (left side of FIG. 4) and subsequently re-activated (right side of FIG. 4). As shown, at block 30 processing device 10 requests that core X (i.e., any one of cores 14-20 of processing circuitry 12) become inactive. At block 32, security module 22 grants permission for core X to enter a power state. Next, at block 34, security module 22 programs in a base address register of fabric 26 the physical location in storage medium 28 (location Y) to be used for context information for core X. At block 36, core X stores its context information using a virtual address at a virtual location in fabric 26 in the manner described above. Fabric 26 then converts (at block 38) the virtual address to the physical location Y of storage medium 28 as programmed by security module 22. Finally, at block 40 fabric 26 stores the context information for core X at location Y in storage medium 28.

At a subsequent time, processing device 10 requests that core X be activated (block 42). As should be apparent from the foregoing, core X of block 42 may be the same core for which context information was stored in blocks 30-40 (such as depicted in FIGS. 2(a)-(d)), or a different core (such as depicted in FIGS. 3(a)-(d)). At block 44 security module 44 grants permission for core X to enter an active state. Next, at block 46 security module 22 provides to the base address register the physical location Y at which the context information for core X is stored on storage medium 28. Core X then requests, at block 48, the context information using the virtual address at the virtual location in fabric 26. At block 50, fabric 26 converts the virtual address to the physical location Y of storage medium 28 provided by security module 22. Finally, at block 52 fabric 26 provides the context information from location Y to core X for continued operation.

Among other advantages, for example, the method and apparatus provides an improved approach to handling storage of context information during power states of operation of a processing circuit (or a core of a processing circuit) to inhibit unauthorized access to the context information and thereby increase security.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method for improving security of context information of processing circuitry, comprising:
storing context information of the processing circuitry on a storage medium at a first location in a process of the processing circuitry entering a first power state; and
storing context information of the processing circuitry on the storage medium at a second location in a process of the processing circuitry entering a second, later and different power state.

2. The method of claim 1, wherein the processing circuitry comprises a plurality of processing cores and storing context information of the processing circuitry comprises storing context information of one of the plurality of cores.

3. The method of claim 2, further comprising:
retrieving the context information from the second location in a process of the processing circuitry exiting the second, later and different power state; and
using the context information for operation of another of the plurality of cores.

4. The method of claim 2, wherein the processing circuitry is an integrated circuit and the storage medium is a separate integrated circuit.

5. The method of claim 4, wherein the storage medium is a DRAM.

6. The method of claim 1, wherein the second, later and different power state is immediately subsequent to the first power state.

7. The method of claim 1, further comprising encrypting the context information before storing the context information.

8. The method of claim 1, further comprising programming in a base address register of the processing circuitry a location of the storage medium for storing the context information.

9. A computer-readable storage medium storing instructions that, when executed by a security module of a processing device having processing circuitry, cause the processing device to:
store context information of the processing circuitry on a storage medium at a first location in a process of the processing circuitry entering a first power state; and
store context information of the processing circuitry on the storage medium at a second location in a process of the processing circuitry entering a second, later and different power state.

10. The computer-readable medium of claim 9, wherein the processing circuitry comprises a plurality of processing cores and stored context information comprises context information of one of the plurality of cores.

11. The computer-readable medium of claim 10, wherein the instructions, when executed by the security module, further cause the processing device to:
retrieve the context information from the second location in a process of the processing circuitry exiting the second, later and different power state; and
use the context information for operation of another of the plurality of cores.

12. The computer-readable medium of claim 9, wherein the storage medium is a DRAM.

13. The computer-readable medium of claim 9, wherein the second, later and different power state is immediately subsequent to the first power state.

14. The computer-readable medium of claim 9, wherein the instructions, when executed by the security module, further cause the processing device to encrypt the context information before storing the context information.

15. The computer-readable medium of claim 9, wherein the instructions, when executed by the security module, further cause the processing device to program in a base address register of the processing circuitry a location of the storage medium for storing the context information.

16. An apparatus, comprising:
processing circuitry;
a memory including a plurality of instructions; and
a security module operatively coupled to the memory and the processing circuitry and configured to execute the instructions to store context information of the processing circuitry on a storage medium at a first location in a process of the processing circuitry entering a first power state, and store context information of the processing circuitry on the storage medium at a second location in a process of the processing circuitry entering a second, later and different power state.

17. The apparatus of claim 16, wherein the processing circuitry comprises a plurality of processing cores and the stored context information comprises context information of one of the plurality of cores.

18. The apparatus of claim 17, wherein the security module facilitates retrieval of the context information from the second location in a process of the processing circuitry exiting the second, later and different power state, the context information being used for operation of another of the plurality of cores.

19. The apparatus of claim 16, wherein the storage medium is a DRAM.

20. The apparatus of claim 16, wherein the second, later and different power state is immediately subsequent to the first power state.

22. The apparatus of claim 16, wherein the security module encrypts the context information before storing the context information.

23. The apparatus of claim 15, wherein the security module programs in a base address register of the processing circuitry a location of the storage medium for storing the context information.
